(19) United States
(12) Patent Application Publication
(10) Pub. No.: US 2007/0179880 A1
(43) Pub. Date: Aug. 2, 2007

(54) Managing negotiation limits in an e-commerce system

(75) Inventors: Howard Borenstein, Downsview (CA); Chang Li, Toronto (CA); Lev Mirlas, Thornhill (CA); Hendra Suwanda, Richmond Hill (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/342,771

(22) Filed: Jan. 30, 2006

(51) Int. Cl. G06Q 40/00; G06Q 99/00; H04K 1/00

(52) U.S. Cl. 705/37; 705/80

(57) ABSTRACT

Embodiments of the present invention address deficiencies of the art in respect to negotiation limits management and provide a novel and non-obvious method, system and apparatus for managing negotiation limits in an e-commerce system. In an embodiment of the invention, an e-commerce data processing system configured for negotiation limit management can include one or more trading agreements defining sales term limits for a sales transaction, pricing logic and negotiation limit logic. The pricing logic can include program code enabled to establish pricing for a customer based upon an established one of the trading agreements. Also, negotiation limit logic can include program code enabled to establish sales term limits for a sales representative also based upon an established one of the trading agreements. Thus, the limitation of negotiation limits for a sales representative can be enforced through the processing of the same type of trading agreement utilized to manage the pricing of a product for a customer.

### BACKGROUND OF THE INVENTION

1. Field of the Invention

The present invention relates to the field of e-commerce and more particularly to the field of computer-assisted negotiations in an e-commerce environment.

2. Description of the Related Art

E-commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined e-commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can so indicate causing the addition of the selected product or service to an on-line shopping cart, though it is also known to bypass the shopping cart model in favor of direct purchase model.

E-commerce systems are not limited to direct sales to consumers. Rather, e-commerce systems often can be utilized by intermediate sales representatives in facilitating sales to consumers. As such, whereas in the direct to consumer sales model, the consumer can purchase goods or services based upon a published price provided through the e-commerce system, in the case of an intermediate sales representative, the price can be negotiated. Generally, in negotiating a price for the sale of goods or services, a sales representative can be bound to a range of acceptable sales prices. In most cases, the range is open ended and includes only a minimum price.

The flexibility afforded to a sales representative to negotiate a sales price for goods or services can vary depending upon the relationship between the sales representative and the seller, and also the perceived skill and seniority of the sales representative. Obviously, sales representatives lacking experience are afforded less leeway in negotiating a price for the sale of goods or services, while trusted sales representatives of significant experience are afforded greater leeway in the negotiation of a price for the sale of goods or services. The same can hold true when a sales representative negotiates a discount to be applied for the benefit of a customer upon a sales price.

Enforcing negotiation limits in an e-commerce system can require the augmentation of the e-commerce system to incorporate a negotiation module. To do so, however, can involve substantial effort and fails to capitalize on existing infrastructure for price establishment provided by conventional e-commerce systems. Accordingly, for many e-commerce systems, the functionality for managing negotiation limits on prices for goods and services can be completely lacking.

### BRIEF SUMMARY OF THE INVENTION

Embodiments of the present invention address deficiencies of the art in respect to negotiation limits management and provide a novel and non-obvious method, system and apparatus for managing negotiation limits in an e-commerce system. In one embodiment of the invention, a negotiation limit management method can include establishing a trading agreement defining sales term limits for a sales transaction, accepting sales terms provided by a sales representative associated with the trading agreement in a proposed sales transaction for an e-commerce system, and enforcing the sales term limits for negotiated sales terms provided by the sales representative in the proposed sales transaction. In this way, the existing infrastructure of the pricing component of the e-commerce system which processes trading agreements can be leveraged to manage limitations on negotiation terms with respect to a sales representative.

In another embodiment of the invention[SMG1], an e-commerce data processing system configured for negotiation limit management can include one or more trading agreements defining sales term limits for a sales transaction, pricing logic and negotiation limit logic. The pricing logic can include program code enabled to establish pricing for a customer based upon an established one of the trading agreements. Also, negotiation limit logic can include program code enabled to establish sales term limits for a sales representative also based upon an established one of the trading agreements. Thus, the limitation of negotiation limits for a sales representative can be enforced through the processing of the same type of trading agreement utilized to manage the pricing of a product for a customer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a system, method and computer program product for managing negotiation limits in an e-commerce transaction;

FIG. 2 is a schematic illustration of an e-commerce data processing system configured for managing negotiation limits;

FIG. 3 is a block diagram illustrating an e-commerce system configured for managing negotiation limits; and,

FIG. 4 is a flow chart illustrating a process for managing negotiation limits in an e-commerce system.

### DETAILED DESCRIPTION OF THE INVENTION

Embodiments of the present invention provide a method, system and computer program product for negotiations limit management in an e-commerce system. In accordance with an embodiment of the present invention, a trading agreement can be established within the e-commerce system between a sales representative and a seller. The trading agreement can include negotiation limits corresponding to pricing limits provided by pricing logic in the e-commerce system. The pricing limits can include, by way of example, limits on pricing, discounts, shipping charges and the like. The pricing limits further can be applied to individual goods and services (collectively, “products”), categories of products, and catalogs of products.

The sales representative can process sales of products to customers utilizing sales logic provided by the e-commerce system. Yet, the pricing of selected aspects of the sales of products can be limited by the terms of trading agreement between the seller and the sales representative. In this regard, the order entry component of the e-commerce system can limit the pricing of the products applied by the sales representative for the customer based upon the pricing limits specified within the trading agreement as managed by the pricing logic of the e-commerce system.

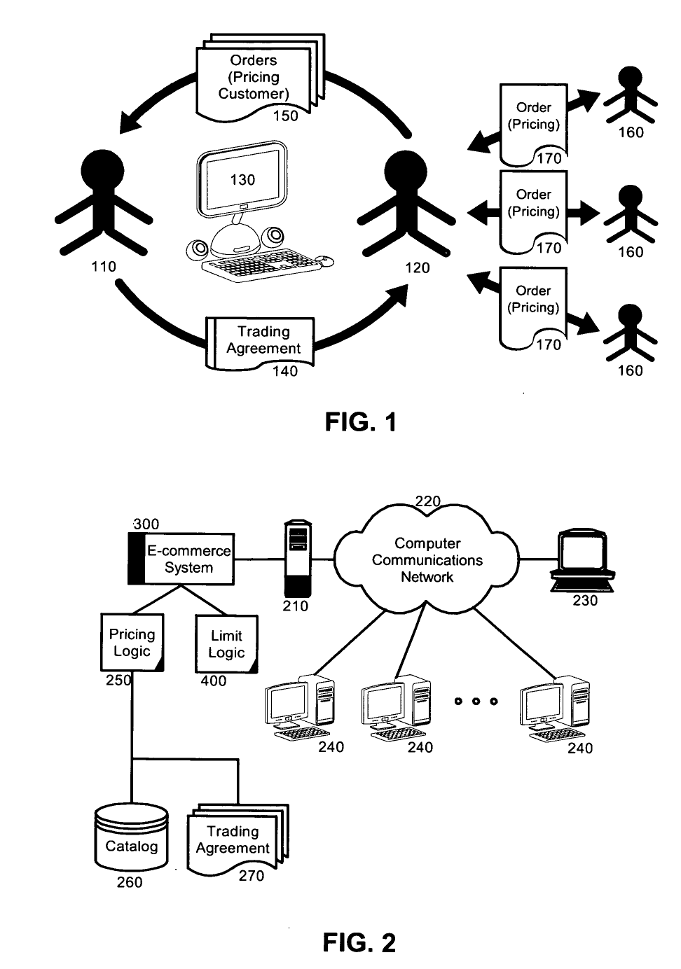

FIG. 1 is a pictorial illustration of a system, method and computer program product for managing negotiation limits in an e-commerce transaction. As shown in FIG. 1, a trading agreement 140 can be established between a seller 110 and a sales representative 120 (or a group of sales representative, or an organization of sales representatives) in an e-commerce system 130. For instance, the trading agreement 140 can specify a set of terms and conditions, a set of participants that qualify for the terms and conditions, and profile information including name, description, state and expiry period for the terms. The sales representative 120 can negotiate separate order 170 with customers 160 at different price terms for each of the customers 160. Once negotiated, each of the orders 150 can be processed in the e-commerce system 130

Importantly, the different price terms negotiated by the sales representative 120 can be limited according to the trading agreement 140 such that the sales representative 120 can offer only so much of a discount or low a price on any term of the sale when negotiating the sale with customers 160. Yet, as the different price terms are limited according to a trading agreement 140, existing pricing logic included within the e-commerce system 130 can manage the application of the limited price terms offered by the sales representative 120 without involving the addition of custom code to the e-commerce system 130. Accordingly, augmentation of the e-commerce system 130 to incorporate a negotiation module is not required.

In more particular illustration, FIG. 2 is a schematic illustration of an e-commerce data processing system configured for managing negotiation limits. The e-commerce data processing system can include a host computing platform 210 hosting an e-commerce system 300. The host computing platform 210 can be coupled to a sales representative computing platform 230 over a computer communications network 220. Likewise, the host computing platform 210 and the sales representative computing platform 230 can be communicatively coupled to customer computing platforms 240 over the computer communications network 220. In this way, each of the sales representative computing platform 230 and the customer computing platforms 240 can access the e-commerce system 300.

Notably, the e-commerce system 300 can be coupled to pricing logic 250 and negotiation limit logic 400. The pricing logic 250 can include program code enabled to manage pricing terms for products listed in a catalog 260 for customers accessing the e-commerce system 300 via the customer computing platforms 240. Specifically, the program code of the pricing logic 250 can be enabled to establish and enforce pricing for individual customers according to a trading agreement 270 established for the customer. As an example, the trading agreement 270 can specify a particular discount or shipping terms based upon the identity of the customer, or metrics associated with the customer.

Preferably, the trading agreement 270 can specify a “floor price” below which a product cannot be priced for an order. For instance, the floor price can be expressed as a percentage minimum markup over cost, or a percentage discount off list price for a product. The limit logic 400, like the pricing logic 250, can include program code enabled to manage negotiation limit terms for products listed in the catalog 260 for a sales representative accessing the e-commerce system 300 via the sales representative computing platform 230. Specifically, the program code of the negotiation logic 400 can be enabled to establish and enforce negotiation limits, for example pricing discounts, according to the trading agreement 270 established for the sales representative. Importantly, the trading agreement 270 for negotiation limits can be enforced in the same way that the trading agreement 270 can be enforced for pricing for products in the catalog 260.

As such, the infrastructure of the pricing logic 250 can be utilized to establish limits for a sales representative in negotiating sales terms in the sale of a product in the catalog 260. In this regard, by reusing the trading agreement infrastructure of the pricing logic 250, the limit logic 400 can utilize several features associated with the pricing logic 250. These features include versioning of trading agreements, activation and de-activation of trading agreements, deployment of trading agreements, customization of trading agreements, including the addition of a new term, and the importing and exporting of trading agreements. Accordingly, since the negotiation limits for the sales representative are expressed as a trading agreement, the retrieval of a floor price able to be offered by the sales representative can be enforced using the same pricing logic that is used to retrieve entitled prices for customers.

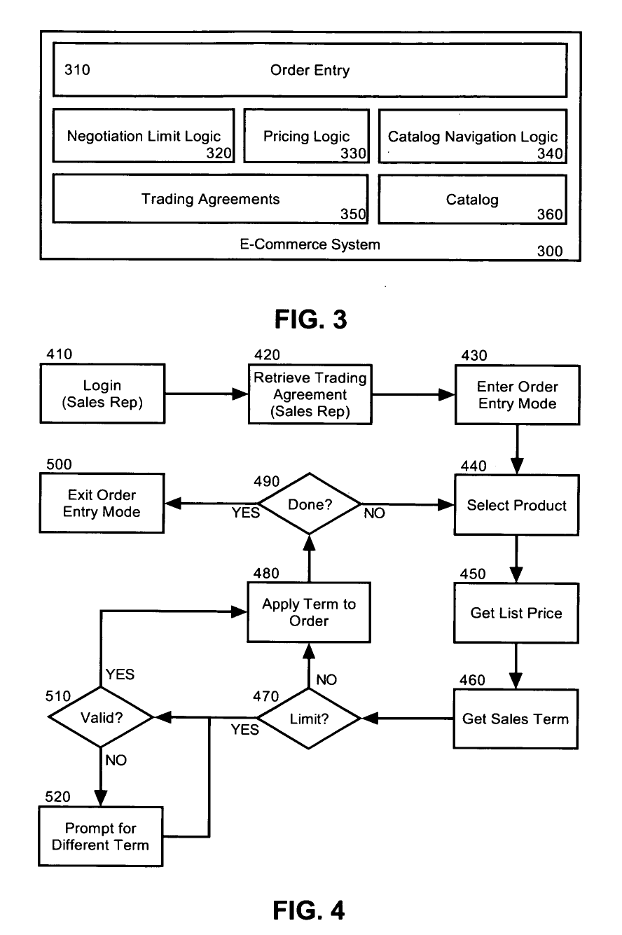

In yet further illustration, FIG. 3 is a block diagram illustrating an e-commerce system configured for managing negotiation limits. The e-commerce system 300 can include an order entry module 310. The order entry module 310 can be coupled to catalog navigation logic 340 enabled to navigate a catalog 360 of products, and pricing logic 330 enabled to enforce pricing terms for products in the catalog 360. The pricing terms can be dictated by trading agreements 350 established for different customers of the e-commerce system 300. Similarly, negotiation limit logic 320 can be enabled to enforce negotiation terms for the sale of products in the catalog 360 according to a trading agreement 350 established for a sales representative of the e-commerce system 300.

In operation, sales terms for the sale of a product to a customer by a sales representative can be limited by the terms of a trading agreement configured for processing by pricing logic of the e-commerce system. In even yet further illustration, FIG. 4 is a flow chart illustrating a process for managing negotiation limits in an e-commerce system. Beginning in block 410, a sales representative can log into an order entry module of an e-commerce system. In block 420, a trading agreement can be retrieved for the sales representative and in block 430, the sales representative can enter an order entry mode.

In block 440, a product can be selected for purchase in the order entry mode. In block 450, a list price can be retrieved for the selected product and in block 460, a sales term, such as a proposed price, discount, or shipping cost can be retrieved for the selected product. In decision block 470, it can be determined whether negotiation limits have been established as between the sales representative and the seller. If not, the retrieved sales term can be applied to an order for the selected product. Otherwise, the process can continue through decision block 510.

In decision block 510, it can be determined whether the sales term offered by the sales representative to a customer falls within an acceptable range defined by the retrieved trading agreement. If not, in block 520 the sales representative can be prompted to provide an alternative sales term to the customer. Optionally, the sales representative can be provided with a specification of a valid range for a sales term to be quoted to the customer as defined within the trading agreement for the sales representative. The process can repeat in decision block 510. Once a valid sales term is determined in block 510, in block 480 the sales term can be applied on behalf of the customer to the order. Subsequently, in decision block 490, it can be determined if no further orders are to be provided. If so, the process can repeat through block 440. Otherwise, the sales representative can exit the order entry mode in block 500.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. In an e-commerce system, a negotiation limit management method comprising:
establishing a trading agreement defining sales term limits for a sales transaction;
accepting sales terms provided by a sales representative associated with the trading agreement in a proposed sales transaction for the e-commerce system; and,
enforcing the sales term limits for negotiated sales terms provided by the sales representative in the proposed sales transaction.

2. The method of claim 1, wherein establishing a trading agreement defining sales term limits for a sales transaction, comprises establishing a trading agreement defining sales term limits for a sales transaction by a sales representative.

3. The method of claim 1, wherein establishing a trading agreement defining sales term limits for a sales transaction, comprises establishing a trading agreement defining sales term limits for a sales transaction by a group of sales representatives.

4. The method of claim 1, wherein establishing a trading agreement defining sales term limits for a sales transaction, comprises establishing a trading agreement defining sales term limits for a sales transaction by an organization of sales representatives.

5. The method of claim 1, wherein establishing a trading agreement defining sales term limits for a sales transaction, comprises establishing a trading agreement defining minimum pricing for a product for a sales transaction.

6. The method of claim 1, wherein establishing a trading agreement defining sales term limits for a sales transaction, comprises establishing a trading agreement defining minimum pricing for a class of products for a sales transaction.

7. An e-commerce data processing system configured for negotiation limit management, the system comprising:
a plurality of trading agreements defining sales term limits for a sales transaction;
pricing logic comprising program code enabled to establish pricing for a customer based upon an established one of the trading agreements; and,
negotiation limit logic comprising program code enabled to establish sales term limits for a sales representative based upon an established one of the trading agreements.

8. The system of claim 7, wherein at least one of the trading agreements comprises:
a floor discount for a sales representative, the floor discount pertaining to at least one sales term selected from the group consisting of price and shipping.

9. The system of claim 8, wherein the floor discount is expressed as one of a percentage discount off a retail price to a customer, and a markup from a cost to a seller.

10. A computer program product comprising a computer usable medium having computer usable program code for negotiation limit management, said computer program product including:
computer usable program code for establishing a trading agreement defining sales term limits for a sales transaction;
computer usable program code for accepting sales terms provided by a sales representative associated with the trading agreement in a proposed sales transaction for an e-commerce system; and,
computer usable program code for enforcing the sales term limits for negotiated sales terms provided by the sales representative in the proposed sales transaction.

11. The computer program product of claim 10, wherein the computer usable program code for establishing a trading agreement defining sales term limits for a sales transaction, comprises computer usable program code for establishing a trading agreement defining sales term limits for a sales transaction by a sales representative.

12. The computer program product of claim 10, wherein the computer usable program code for establishing a trading agreement defining sales term limits for a sales transaction, comprises computer usable program code for establishing a trading agreement defining sales term limits for a sales transaction by a group of sales representatives.

13. The computer program product of claim 10, wherein the computer usable program code for establishing a trading agreement defining sales term limits for a sales transaction, comprises computer usable program code for establishing a trading agreement defining sales term limits for a sales transaction by an organization of sales representatives.

14. The computer program product of claim 10, wherein the computer usable program code for establishing a trading agreement defining sales term limits for a sales transaction, comprises establishing a trading agreement defining minimum pricing for a product for a sales transaction.

15. The computer program product of claim 10, wherein the computer usable program code for establishing a trading agreement defining sales term limits for a sales transaction, comprises computer usable program code for establishing a trading agreement defining minimum pricing for a class of products for a sales transaction.
